(19) United States
(12) Patent Application Publication
(10) Pub. No.: US 2023/0245035 A1
(43) Pub. Date: Aug. 3, 2023

(54) SHIPMENT OF MULTIPLE ITEMS FROM MULTIPLE SELLERS

(71) Applicant: eBay Inc., San Jose, CA (US)

(72) Inventor: Alpha Kamchiu Luk, San Jose, CA (US)

(21) Appl. No.: 17/592,243

(22) Filed: Feb. 3, 2022

(51) Int. Cl. G06Q 10/08

(52) U.S. Cl. CPC G06Q 10/083

(57) ABSTRACT

A system for distributing items is provided. Requests from first users for items available from second users are received. The first users are associated with different shipping addresses. Clusters are identified from the requests. The clusters have items with similar characteristics and are requested by different first users. The clusters are then matched to individuals of the second users. First instructions for the individuals are generated that indicate a single shipment having items purchased by the first users are to be sent to a processor. Second instructions are generated for the processor. The second instructions include sorting instructions to sort the items from shipments received from the individuals. The second instructions include address instructions to determine shipping addresses for the first users. The second instructions include packaging instructions for packaging the sorted items according to the shipping addresses such that a single package is sent to individual first users.

### TECHNICAL FIELD

The subject matter disclosed herein generally relates to generating machine instructions. Specifically, in some examples, the present disclosure provides instructions that consolidate items to be sent to various recipients.

### BACKGROUND

An online seller may offer free and/or reduced cost shipping when a buyer purchases items that exceed a preset amount. For example, if a buyer purchases items that exceed $100, the buyer may be entitled to free shipping where the seller covers the cost of shipping. The seller is able to cover the cost of shipping while still maintaining a profit margin that makes covering shipping worth the cost. However, in these scenarios, the buyer must purchase items from the seller that exceed a preset amount. If a buyer does not purchase items from the seller that exceed the preset amount, the cost associated with shipping the item may not allow the seller to retain enough of a profit in order to make covering the cost of shipping viable. Thus, the buyer may instead choose to purchase the item from a seller willing to cover the cost of shipping.

### BRIEF DESCRIPTION OF THE DRAWINGS

Some examples are illustrated by way of example and not limitation in the figures of the accompanying drawings.

FIG. 1 illustrates an environment 100 that facilitates the buying and selling of items is shown, according to some examples.

FIG. 2 illustrates a method that consolidates items sold by multiple sellers and sends the items to buyers who purchased the items, according to some examples.

FIG. 3 illustrates a user interface that may be used to search for items to purchase, according to some examples.

FIG. 4 illustrates a user interface that may be used to display items searched for with the user interface shown with reference to FIG. 3, according to some examples.

FIG. 5 illustrates a purchase request that is generated in response to a user selecting an item to purchase, according to some examples.

FIG. 6 illustrates a user interface that may be used to display items searched for with the user interface shown with reference to FIG. 3, according to some examples.

FIG. 7 illustrates a purchase request that is generated in response to a user selecting an item to purchase, according to some examples.

FIG. 8 illustrates a user interface that may be used to display items searched for with the user interface shown with reference to FIG. 3, according to some examples.

FIG. 9 illustrates a purchase request that is generated in response to a user selecting an item to purchase, according to some examples.

FIG. 10 shows a data table that matches items to sellers, according to some examples.

FIG. 11 is a block diagram illustrating an example of a software architecture that may be installed on a machine, according to some examples.

FIG. 12 is a diagrammatic representation of a machine in the form of a computer system within which a set of instructions may be executed for causing the machine to perform any one or more of the methodologies discussed herein, according to some examples.

### DETAILED DESCRIPTION

Examples are directed to systems and methods that consolidate items sold from multiple sellers and sends the consolidated items to multiple buyers who purchased the items. In an example, a plurality of buyers can buy items being sold by a plurality of sellers. To further illustrate, three sellers can be selling three different types of home furnishings, such as bedding, area rugs, and dinnerware. In this illustration, first, second, and third buyers can be remotely located in relation to each other and can separately purchase each of the three different items. Each of the buyers sends their individual orders to a selling platform, which then disseminates the individual orders to the plurality of sellers for fulfillment. When each of the plurality of sellers receives an individual order for an item being sold by the seller, after a period of time elapses, each of the sellers fulfills the individual orders by sending the items to a processing center. The processing center then sends the purchased items to each of the buyers.

In the home furnishings illustration, first, second, and third buyers may purchase bedding, area rugs, and dinnerware over a three day period. During this three day period, the three buyers submit bedding, area rugs, and dinnerware purchase requests to the selling platform. The selling platform disseminates the bedding purchase requests to the bedding seller as the purchase requests are received from the buyers during the three day period. The selling platform also disseminates the rug purchase requests to the area rug seller as the purchase requests are received from the buyers during the three day period. In addition, the selling platform disseminates the dinnerware purchase requests to the dinnerware seller as the purchase requests are received from the buyers during the three day period.

After expiration of the period of time, each of the sellers sends the items for the buyers in a single package to a processing center. In the illustration, the time period can be three days. Thus, after three days, the bedding seller sends bedding purchased by the buyers in the last three days in a single package to the processing center. Moreover, the area rug seller sends area rugs purchased by the buyers in the last three days in a single package to the same processing center. Likewise, the dinnerware seller sends dinnerware purchased by the buyers in the last three days in a single package to the same processing center.

Once the processing center receives the packages from the sellers, the processing center repackages the items purchased by the buyers into individual packages that are to be sent to each of the buyers. Thus, the bedding, the area rug, and the dinnerware intended for the first buyer received from each of the sellers is sent in one package to the first buyer. Likewise, the bedding, the area rug, and the dinnerware intended for the second buyer received from each of the sellers is sent in one package to the second buyer. In addition, the bedding, the area rug, and the dinnerware intended for the third buyer received from each of the sellers is sent in one package to the third buyer.

Examples address problems associated with a seller who sells the same item to multiple buyers having to separately send the sold items to different buyers where, depending on location, the seller sends the same item in all of the packages to a single processing center. In the bedding scenario above, the seller may have sold bedding items to three different buyers. Typically, the seller would have to put the bedding item intended for a first buyer in a first package, the bedding item intended for a second buyer in a second package, and the bedding item intended for a third buyer in a third package, where, in some instances, the first, second, and third packages are being sent to a single processing center. Examples address this problem by allowing the seller to place the bedding items for all three buyers in a single package and then send the single package to the single processing center where the process of sending different packages to different buyers can be automated at the single processing center.

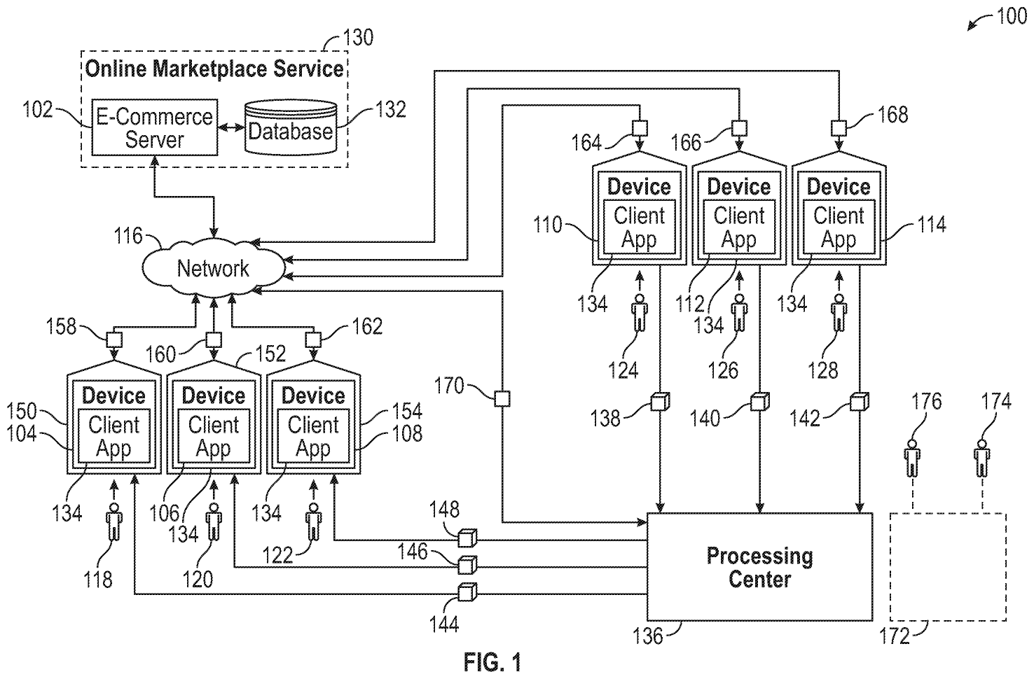

Now making reference to the Figures, an example of an environment in which examples that provide the functionality discussed above is shown with reference to FIG. 1. FIG. 1 illustrates an environment 100 that facilitates the buying and selling of items, according to some examples. The environment 100 includes a selling platform 102, such as an e-commerce server, along with user devices 104-114 communicatively coupled to each other via a network 116. The selling platform 102 can further provide functionality that enables buyers 118-122 respectively associated with the user devices 104-108 to purchase, submit an offer, and/or bid on an item listed for sale by sellers 124-128 respectively associated with the user devices 110-114. For example, the selling platform 102 can provide user interface elements (e.g., button, text fields) that one of the buyers 118-122 can use to select to purchase an item, place a bid, etc., as well as provide their financial (e.g., credit card number, bank account number) and personal information (e.g., shipping address, billing address) to complete the purchase. To view listings and/or purchase/bid on listed items, a buyer can create a user account with an online marketplace service 130.

The online marketplace service 130 can be a network-based system that can include one or more computing devices configured to facilitate an online marketplace (e.g., EBAY, AMAZON) in which users may post items for sale and purchase items posted for sale by other users. For example, the online marketplace service 130 provides a user interface that enables users to view listings posted to the online marketplace service 130. Each listing provides details for an item or items listed for sale. For example, the listing may include an item description, images, sale price, current bid price, auction time remaining, shipping options, aspects, customer reviews, etc.

The selling platform 102 can further provide functionality that enables a user to purchase, submit an offer, and/or bid on an item listed for sale. For example, the selling platform 102 can provide user interface elements (e.g., button, text fields) that a user may use to select to purchase an item, place a bid, etc., as well as provide their financial (e.g., credit card number, bank account number) and personal information (e.g., shipping address, billing address) to complete the purchase. To view listings, purchase/bid on listed items, and/or perform other functionalities provided by the selling platform 102, a user may create a user account with the selling platform 102.

The user devices 104-114 can be any type of computing device, such as desktop computers; mobile computers; mobile communications devices, e.g., mobile phones, smart phones, tablets; smart televisions; set-top boxes; and/or any other network enabled computing devices. A computing device is any type of general computing device capable of network communication with other computing devices.

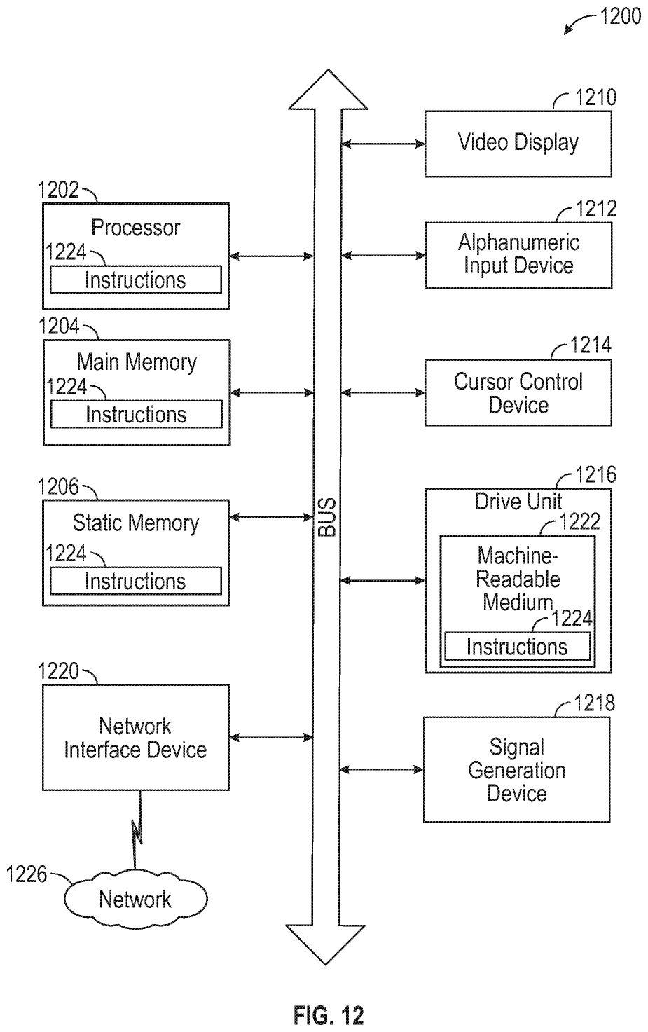

For example, a computing device can be a personal computing device such as a desktop or workstation, a business server, or a portable computing device, such as a laptop, smart phone, or a tablet personal computer (PC). A computing device can include some or all of the features, components, and peripherals of the machine 1200 shown in FIG. 12.

To facilitate communication with other computing devices, a computing device includes a communication interface configured to receive a communication, such as a request, data, and the like, from another computing device in network communication with the computing device and pass the communication along to an appropriate module running on the computing device. The communication interface also sends a communication to another computing device in network communication with the computing device.

In the environment 100, users, such as the buyers 118-112 and the sellers 124-128, interact with the selling platform 102 to utilize the services provided by the selling platform 102. The selling platform 102 provides an online marketplace in which users may post items for sale and purchase items posted for sale by other users. For example, the selling platform 102 may include items being auctioned for sale and/or items listed for sale at a set price. Users communicate with and utilize the functionality of the selling platform 102 by using the user devices 104-114 that are connected to the network 116 by direct and/or indirect communication.

The network 116 can be any type of communication network, including a local area network (LAN), such as an intranet, a wide area network (WAN), such as the internet, or any combination thereof. Further, the network 116 may be a public network, a private network, or a combination thereof. The network 116 is implemented using any number of communication links associated with one or more service providers, including one or more wired communication links, one or more wireless communication links, or any combination thereof. Additionally, the network 116 is configured to support the transmission of data formatted using any number of protocols.

To list an item for sale on the online marketplace, the sellers 124-128 can create a user account with the selling platform 102. The user account may include the personal information (e.g., name, address, email address, phone number) and financial information (e.g., credit card information, bank account information) associated with the seller 124-128. Once the sellers 124-128 have created a user account, the sellers 124-128 can then use their user account to utilize the functionality of the selling platform 102, including listing an item for sale.

The selling platform 102 can be part of the online marketplace service 130 that includes a cloud-based database 132. Examples of the database 132 can include the Simple Storage Service offered by Amazon Web Services™. Other examples of the database 132 can include a SwiftStack™ object storage system.

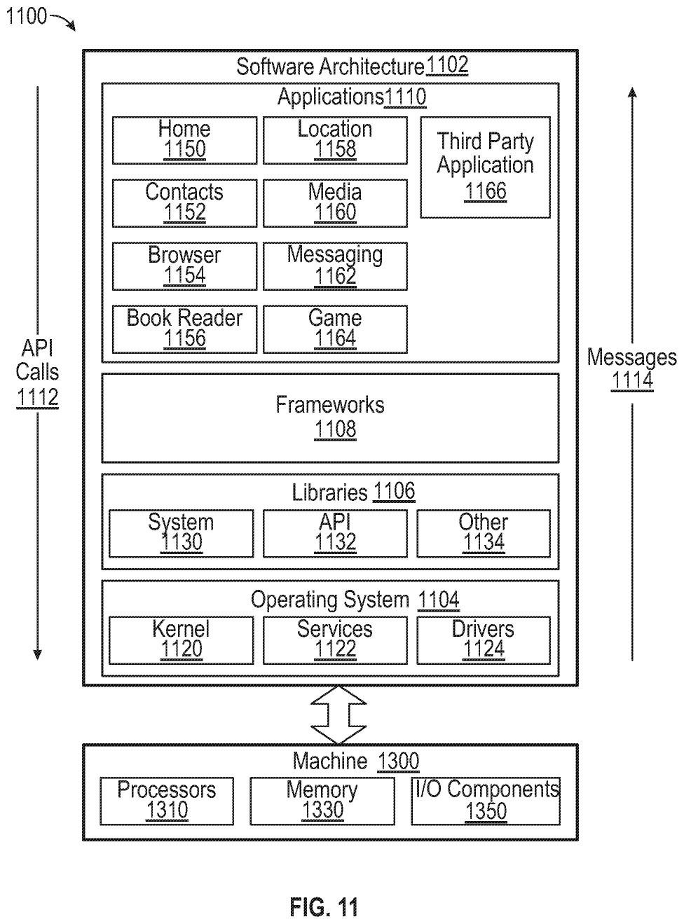

A user, such as one of the buyers 118-122 or one of the sellers 124-128, or both, interacts with the selling platform 102 via a client-side application 134 installed on the user devices 104-114. In some examples, the client-side application 134 can include a component specific to the online marketplace service 106. For example, the component may be a stand-alone application, one or more application plug-ins, and/or a browser extension. However, the users may also interact with the selling platform 102 via a third-party application, such as a web browser, that resides on the client devices 104-114 and is configured to communicate with the selling platform 102. In either case, the client-side application 134 can present a user interface (UI), such as the user interfaces discussed further on, for the user, to interact with the selling platform 102. For example, the user interacts with the selling platform 102 via the client-side application 134 integrated with the file system or via a webpage displayed using a web browser application. The selling platform 102 and the user devices 104-114 can each be implemented in a computer system, in whole or in part, as described below with respect to FIGS. 11 and 12. The selling platform 102 can provide an electronic commerce application to other machines (e.g., the user devices 104-108) via the network 116. The electronic commerce application may provide a way for users to buy and sell items directly to each other, to buy from and sell to the electronic commerce application provider, or both.

The environment 100 also includes a processing center 136 that receives packages 138-142 from each of the sellers 124-128. The packages 138-142 can include items the buyers 118-122 bought from the sellers 124-128. In an example, the items in the packages 138-142 are repackaged into packages 144-148 at the processing center 136. After repackaging, the packages 144-148 are respectively sent to locations 150-154, such as domiciles, places of employment, or any destination associated with each of the buyers 118-122 where each of the buyers can physically receive the packages 144-148.

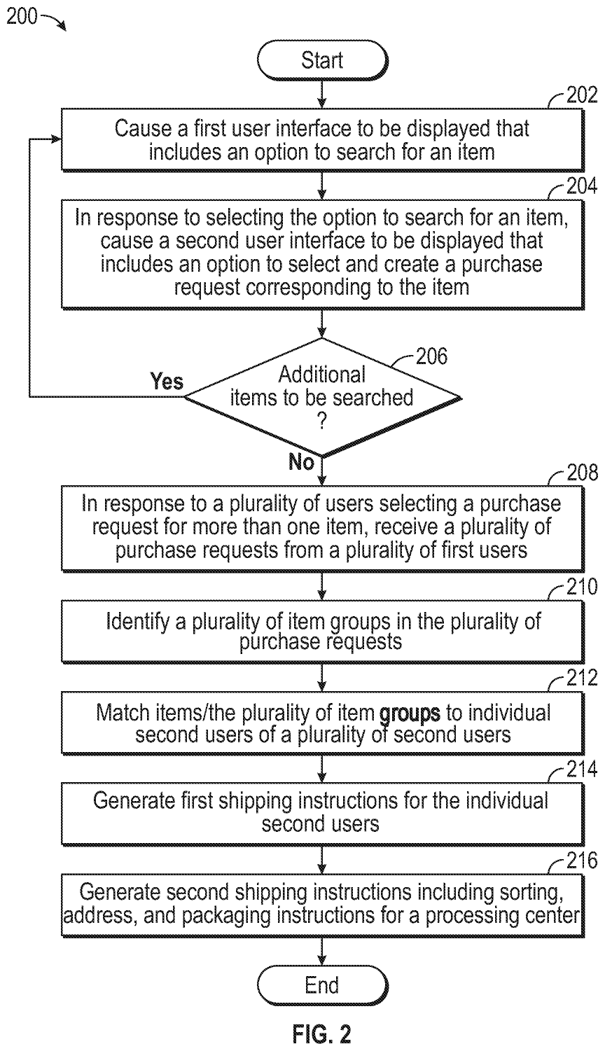

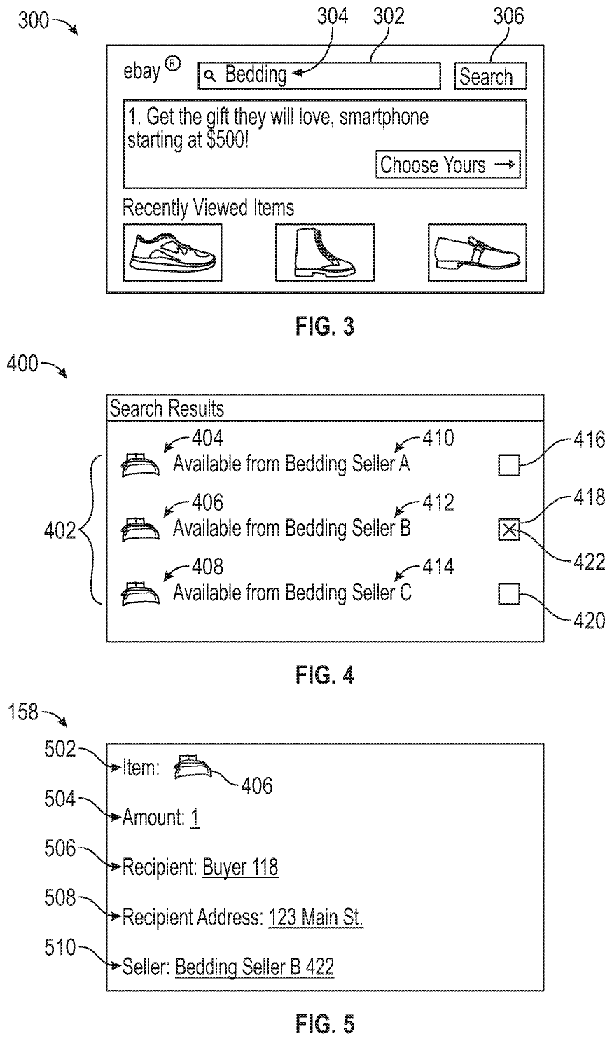

As noted above, examples relate to consolidating items sold from multiple sellers and sending the items to multiple buyers who purchased the items. To further illustrate these principles, reference is now made to FIG. 2 and a method 200 that consolidates items sold by multiple sellers and sends the items to buyers who purchased the items. Initially, in an operation 202, a first user interface is caused to be displayed at a first user device that includes an option to search for an item. In an example, the selling platform 102 causes a user interface to be displayed at user devices associated with potential buyers. An example of a user interface that can be displayed is a user interface 300, as shown with reference to FIG. 3.

The user interface 300 can include an input field 302 where a user can input a search term 304 that correlates to an item the user is interested in purchasing. Moreover, the user interface 300 can include a button 306 that provides the user an option to search for an item associated with the search term 304. In an example, a first user interface, such as the user interface 300, can be displayed at multiple user devices at various times. In addition, in an example, the first user interface, such as the user interface 300, can be simultaneously displayed at multiple user devices. In an example, during the operation 202, the first user interface can be displayed multiple times, such as in the instance when a user wants to purchase multiple items. Furthermore, during the operation 202, the first user can engage the button 306, which can correlate to the user selecting an option to search for an item.

As an example, multiple users can be interested in purchasing home furnishings, such as the aforementioned bedding, area rugs, and dinnerware. In the example, during the operation 202, the selling platform 102 causes the user interface 300 to be displayed on the user devices 104-108 associated with first users, such as the buyers 118-122. In an example, the selling platform 102 can cause the user interface 300 to be displayed on the user devices 104-108 at the same time or at different times. In the example, the buyer 118 enters “Bedding” as the search term 304 during the operation 202. Once the buyer 118 enters the term “Bedding” as the search term 304, the buyer 118 engages the search button 306 during the operation 202 such that the buyer 118 selects the option to search for bedding. In an example, engaging the search button 306 can include clicking on the search button 306 or any other engagement means known to those skilled in the art.

In the example, during the operation 202, the selling platform 102 can cause the user interface 300 to be displayed on the user devices 106 and 108 associated with the buyers 120 and 122 in addition to the user device 104 associated with the buyer 118. Thus, during the operation 202, the buyers 120 and 122 also enter “Bedding” as the search term 304 on the user interfaces 300 respectively displayed on the user devices 106 and 108. Additionally, once the buyers 120 and 122 enter the term “Bedding” as the search term 304, the buyers 120 and 122 each engage the search button 306 similar to the buyer 118 during the operation 202 such that the buyers 120 and 122 select the option to search for bedding. Once the option to search for bedding is selected, the method 200 performs an operation 204.

Returning attention to FIG. 2 and the method 200, in response to selecting the option to search for an item, the selling platform 102 displays a second user interface during the operation 204. In an example, the second user interface that is displayed during the operation 204 can include an option to select and create a purchase request corresponding to the item searched for in the operation 202. An example of the user interface that can be displayed can include a user interface 400 shown with regards to FIG. 4.

The user interface 400 can display search results 402 that include bedding items 404-408 corresponding to the search term 304 entered by the first user at the input field 302 in the user interface 300. In addition, the user interface 400 can display sellers 410-414 selling each of the bedding items 404-408. To further illustrate, Bedding Seller A 410 sells the item 404, Bedding Seller B 412 sells the item 406, and Bedding Seller C 414 sells the item 408. The user interface 400 includes checkboxes 416-420 respectively corresponding to the Bedding Sellers A-C 410-414. In an example, if a first user desires the bedding item 406 sold by the Bedding Seller B 412, the first user can engage the checkbox 418, such as by placing a checkmark 422 within the checkbox 418, as shown with reference to FIG. 4. While an “X” is shown as the checkmark 422, any type of indicia can be used for the checkmark 422.

In an example, the checkboxes 416-420 correspond to an option to select and create a purchase request for the item corresponding to the checkbox. As an illustration, when the checkmark 422 is placed within the checkbox 418, in the operation 204, this can correspond to selecting an option to select and create a purchase request corresponding to the item 404, such as a purchase request 158 shown with reference to FIG. 5.

Now making reference to FIG. 5, the purchase request 158 can list item 502 along with an amount 504 of the item 502 to be purchased. In addition, the purchase request 158 can identify the recipient 506 of the item and a recipient address 508 associated with the recipient 506. In an example, the item 502 can correspond to the bedding item 406 selected by the user via the user interface 400, such as the bedding item 406. The amount 504 can correspond to a number of the items 502 the user wants, which is one item. The recipient 506 identifies the user while the recipient address 508 lists an address associated with the recipient. Additionally, the purchase request 158 can include seller identification 510, which lists the seller that is selling the bedding item 406. Here, the Bedding Seller B 412 sells the bedding item 406.

To further illustrate the operation 204, in the example, after the buyer 118 engages the search button 306 as noted above, the selling platform 102 displays the user interface 400 on the user device 104 during the operation 204. The user interface 400 displays the items 404-408, which correspond to bedding that the buyer 118 was searching for in the operation 202. In this example, the buyer 118 wants one of the bedding item 406. Thus, the buyer places the checkmark 422 in the checkbox 418. Furthermore, during the operation 204 in the example, the selling platform 102 displays the user interface 400 on the user devices 106 and 108 associated with the buyers 120 and 122 in response to the buyers 120 and 122 each engaging the search button 306 on the user interfaces 300 respectively displayed on the user devices 106 and 108. Similar to the buyer 118, each of the buyers 120 and 122 want one of the bedding item 406. Thus, each of the buyers 120 and 122 place the checkmark 422 in the checkbox 418 on the user interfaces 400 respectively displayed on the user devices 106 and 108 during the operation 204. It should be noted that in accordance with some examples, each of the buyers 118-122 could choose as many of the bedding items 406 as they want. To further illustrate, the buyer 120 could choose two of the bedding items 406 and the buyer 122 could choose three of the bedding items 406.

During the operation 204, as result of the buyer 118 selecting the bedding item 406, the purchase request 158 is selected and created, where the purchase request 158 lists the item 502 as corresponding to the bedding item 406 selected by the buyer 118. In addition, the purchase request 158 lists an amount as one bedding item 406, identifies the recipient 506 as the buyer 118, and lists the recipient address 508 as 123 Main Street, which, in the example, is the address where the buyer 118 receives packages. In addition to the purchase request 158 associated with the buyer 118, similar purchase requests 158 are selected and created for each of the buyers 120 and 122 when each of the buyers 120 and 122 select the bedding item 406 in the example during the operation 204.

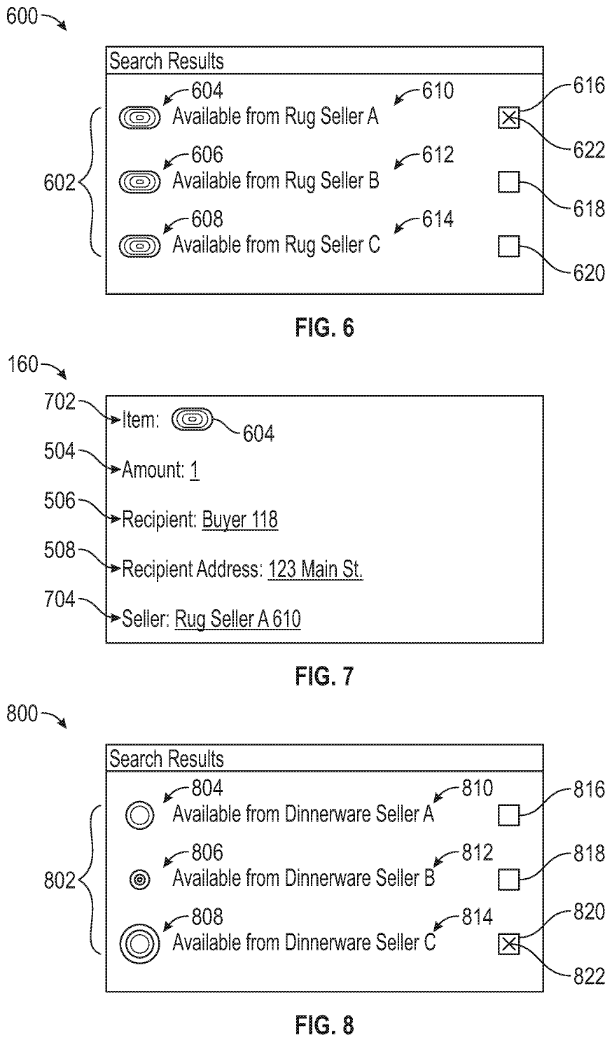

Returning attention to FIG. 2 and the method 200, after the operation 204, the method 200 performs an operation 206, where a determination is made if additional items are to be searched. Returning to the example, after each of the buyers 118-122 select the bedding item 406 in the operation 204, the method 200 determines that additional items are to be searched in the operation 206. In particular, in the example, the buyers 118-122 are interested in purchasing area rugs and dinnerware. Therefore, the operations 202 and 204 are repeated. Regarding area rugs, during the operation 202, each of the buyers 118-122 input “area rugs” as a search term at the input field 302 (not shown). In response to entering area rugs as a search term at the input field 302, the selling platform 102 causes a user interface 600 to be displayed at each of the user devices 104-106 associated with the buyers, as shown with reference to FIG. 6.

In the example, the user interface 600 can display search results 602 that include area rug items 604-608 corresponding to the search term 304 (“area rugs”) entered by the first user at the input field 302 in the user interface 300. In addition, the user interface 600 displays Rug Sellers A-C 610-614 selling each of the area rug items 604-608. To further illustrate, Rug Seller A 610 sells the area rug item 604, Rug Seller B 612 sells the area rug item 606, and Rug Seller C 614 sells the area rug item 608. The user interface 600 includes checkboxes 616-620 respectively corresponding to the Rug Sellers A-C 610-614. In an example, if the buyer 118 desires the area rug item 604 sold by the Rug Seller A 610, the buyer 118 can engage the checkbox 616, such as by placing a checkmark 622 within the checkbox 616, as shown with reference to FIG. 6. While an “X” is shown as the checkmark 622, any type of indicia may be used for the checkmark 622. Similar to the buyer 118, each of the buyers 120 and 122 also want the area rug item 604 sold by the Rug Seller A 610. Thus, in the example, each of the buyers 120 and 122 place the checkmark 622 in the checkbox 616 on the user interfaces 600 respectively displayed on the user devices 106 and 108 during the operation 204.

In the example, the checkboxes 616-620 correspond to an option to select and create a purchase request for the item corresponding to the checkbox. In the example, the buyer 118 desires to purchase the area rug item 604 from the Rug Seller A, thus the checkmark 622 is placed within the checkbox 616. In the operation 204, placing the checkmark 622 within the checkbox 616 can correspond to selecting an option to select and create a purchase request corresponding to the item, such as a purchase request 160 shown with reference to FIG. 7.

Now making reference to FIG. 7, in the example, the purchase request 160 can list an item 702 along with the amount 504 of the item to be purchased. In addition, the purchase request can identify the recipient 506 of the item and the address 508 associated with the recipient 506. In the example, the item 702 corresponds to the item selected by the user via the user interface 600, which is the area rug item 604. The amount can correspond to a number of the items 702 the user wants. Here, the buyer 118 selected one area rug item 604. Additionally, the purchase request 160 can include seller identification 704, which lists the seller that is selling the area rug item 604. Here, the Rug Seller A 610 sells the area rug item 604. In addition to the purchase request 160 associated with the buyer 118, purchase requests 160 for each of the buyers 120 and 122 are created when each of the buyers 120 and 122 select the area rug item 604 in the example. Moreover, it should be noted that in accordance with some examples, each of the buyers 118-122 could choose as many of the area rug items 604 as they want. To further illustrate, the buyer 120 could choose two of the area rug items 604 and the buyer 122 could choose three of the area rug items 604.

As noted above, each of the buyers 118-122 are also interested in purchasing dinnerware. Thus, the operations 202 and 204 are repeated in response to determining that additional items are to be searched during the operation 206. Regarding dinnerware, during the operation 202, each of the buyers 118-122 input “dinnerware” as a search term at the input field 302 (not shown). In response to entering dinnerware as a search term at the input field 302, the selling platform 102 causes a user interface 800 to be displayed at each of the user devices 104-106 associated with the buyers, as shown with reference to FIG. 8.

The user interface 800 can display search results 802 that include dinnerware items 804-808 corresponding to the search term 304 (“dinnerware”) entered by the first user at the input field 302 in the user interface 300. In addition, the user interface 800 displays Dinnerware Sellers A-C 810-814 selling each of the dinnerware items 804-808. To further illustrate, Dinnerware Seller A 810 sells the dinnerware item 804, Dinnerware Seller B 812 sells the dinnerware item 806, and Dinnerware Seller C 814 sells the dinnerware item 808. The user interface 800 includes checkboxes 816-820 respectively corresponding to the Dinnerware Sellers A-C 810-814. In the example, the buyer 118 desires the dinnerware item 808 sold by the Dinnerware Seller C 814. Accordingly, the buyer 118 engages the checkbox 820, such as by placing a checkmark 822 within the checkbox 820, as shown with reference to FIG. 8. While an “X” is shown as the checkmark 822, any type of indicia may be used for the checkmark 822. Similar to the buyer 118, each of the buyers 120 and 122 also want the dinnerware item 808 sold by the Dinnerware Seller C 814. As such, each of the buyers 120 and 122 place the checkmark 822 in the checkbox 820 on the user interfaces 800 respectively displayed on the user devices 106 and 108 during the operation 204.

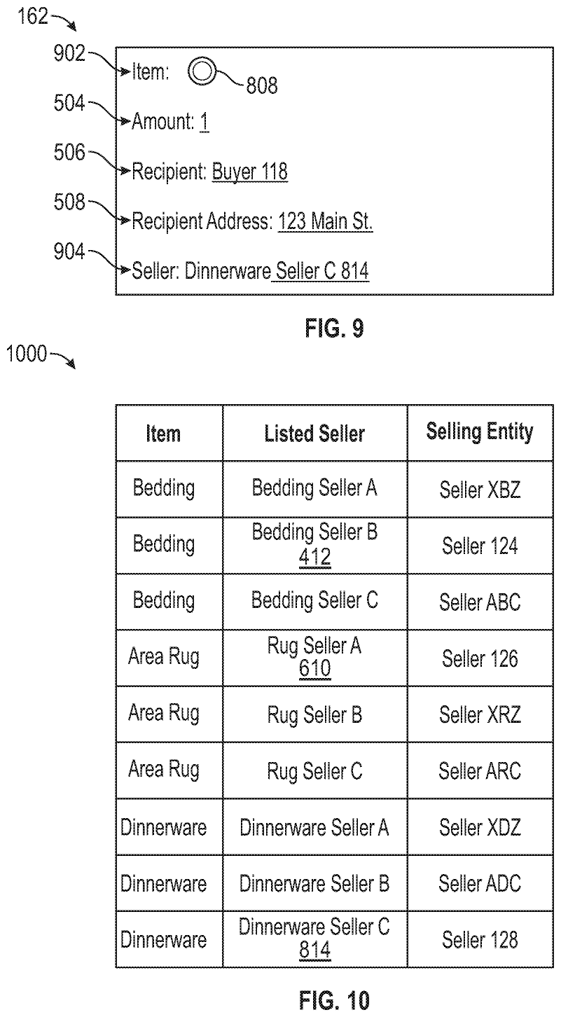

In the example, the checkboxes 816-820 can correspond to an option to select and create a purchase request for the item corresponding to the checkbox. In the example, the buyer 118 desires to purchase the dinnerware item 808 from the Dinnerware Seller C, thus the checkmark 822 is placed within the checkbox 820. In the operation 204, placing the checkmark 822 within the checkbox 820 can correspond to selecting an option to select and create a purchase request corresponding to the item, such as a purchase request 162 shown with reference to FIG. 9.

Now making reference to FIG. 9, in the example, the purchase request 162 can list an item 902 along with the amount 504 of the item to be purchased. Here, the buyer 118 has requested one of the dinnerware items 808. In addition, the purchase request can identify the recipient 506 of the item and the address 508 associated with the recipient 506. In the example, the item 902 corresponds to the item selected by the user via the user interface 800, which is the dinnerware item 808. Additionally, the purchase request 162 can include seller identification 904, which lists the seller that is selling the dinnerware item 808. Here, the Dinnerware Seller C 814 sells the dinnerware item 808. The amount can correspond to a number of the dinnerware items 808 the user wants, which in the example is one dinnerware item (in this example, the dinnerware item can correspond to a full set of dinnerware, e.g., dinner plates, salad plates, bowls, cups). In addition to the purchase request 162 associated with the buyer 118, similar purchase requests 162 are selected and created when each of the buyers 120 and 122 select the dinnerware item 808 in the example. It should be noted that in accordance with some examples, each of the buyers 118-122 could choose as many of the dinnerware items 408 as they want. To further illustrate, the buyer 120 could choose two of the dinnerware items 408 and the buyer 122 could choose three of the dinnerware items 408.

Making reference again to FIG. 2, when the method 200 determines that no additional items are to be searched, an operation 208 is performed. During the operation 208, in response to a plurality of users selecting a purchase request for more than one item, a plurality of purchase requests is received from the plurality of users at the selling platform 102.

The selling platform examines the plurality of purchase requests to identify pluralities of item groups in the plurality of purchase requests during an operation 210. In an example, item groups can refer to groups that have the same items.

To further illustrate the operations 208 and 210, in the example, the selling platform 102 receives the purchase requests 158-162 during the operation 208. With respect to the purchase requests 158-162, each of the buyers 118-122 included a request for the bedding item 406 available from the Bedding Seller B 412. Thus, during the operation 210, the selling platform 102 identifies the bedding items 406 as an item group. With regards to the purchase request 160, in the example, each of the buyers 118-122 included a request for the area rug item 604 available from the Rug Seller A 610.

During the operation 210, the selling platform 102 identifies the area rug items 604 as an item group. As noted above, item groups can refer to groups that include the same item. In the example, the area rug items 604 are area rugs.

Furthermore, in the example, each of the buyers 118-122 included a request for the dinnerware item 808 available from the Dinnerware Seller C 814 in the purchase request 162. As such, during the operation 210, the selling platform 102 identifies the dinnerware items 808 as an item group.

Returning to FIG. 2 and the method 200, after the operation 210, the method 200 performs an operation 212, where the plurality of item clusters is matched to individual second users of a plurality of second users. In an example, the second users can correspond to the sellers, such as the sellers 124-128. Moreover, an individual second user of the plurality of second users can be one of the sellers 124-128. Thus, in an example, the seller 124 can be an individual user of the plurality of second users, the seller 126 can be an individual user of the plurality of second users, and the seller 128 can be an individual user of the plurality of second users. During the operation 212, the selling platform can determine the individual second user from the purchase requests received during the operation 208. As noted above, the purchase requests list the seller selling the selected item. Using the listed seller in the purchase request, the selling platform 102 can match the item groups to an individual second user using a data table stored at the database 132.

To further illustrate the operation 212, in the example, after the selling platform 102 identifies the bedding items 406 as an item group, the selling platform 102 identifies the Bedding Seller B 412 as the seller. The selling platform 102 identifies the Bedding Seller B 412 as the seller from the purchase request 158, which lists the Bedding Seller B 412 at the seller identification 510. Moreover, the selling platform 102 identifies the seller 124 as the Bedding Seller B 412. In particular, the selling platform accesses a data table 1000 shown with reference to FIG. 10 and matches the Bedding Seller 412 B with the seller 124. Thus, the selling platform 102 matches the bedding items 406 to the seller 124 during the operation 212. Furthermore, in the example, the seller 124 is an individual second user since the seller 124 sells the bedding items 406.

Furthermore, in the example, during the operation 212, after the selling platform 102 identifies the area rug items 604 as an item group, the selling platform 102 identifies the Rug Seller A 610 as the seller. The selling platform 102 identifies the Rug Seller A 610 as the seller from the purchase request 160, which lists the Rug Seller A 610 at the seller identification 704. Moreover, the selling platform 102 identifies the seller 126 as the Rug Seller A 610. In particular, the selling platform accesses the data table 1000 and matches the Rug Seller A 610 with the seller 126. Thus, the selling platform 102 matches the area rug items 604 to the seller 126 during the operation 212. Furthermore, in the example, the seller 126 is an individual second user since the seller 126 sells the area rug items 406.

In the example, also during the operation 212, after the selling platform 102 identifies the dinnerware items 808 as an item group, the selling platform 102 identifies the Dinnerware Seller C 814 as the seller. The selling platform 102 identifies the Dinnerware Seller C 814 as the seller from the purchase request 162, which lists the Dinnerware Seller C 814 at the seller identification 904. In particular, the selling platform accesses the data table 1000 and matches the Dinnerware Seller C 814 with the seller 128. Thus, the selling platform 102 matches the dinnerware items 808 to the seller 128 during the operation 212. Furthermore, in the example, the seller 128 is an individual second user since the seller 128 sells the dinnerware items 808.

In an example, upon completion of the operation 212, the method 200 performs an operation 214, where the selling platform 102 generates first shipping instructions for each of the individual users identified in the operation 212, as shown with reference to FIG. 2. During the operation 214, the selling platform generates instructions 164-168 based on the item groups identified during the operation 210 and the individual second users identified during the operation 212. Each of the instructions 164-168 describe an item that is to be sold by the individual second user, an amount of the items, and an address to which the items are to be sent. In an example, each of the instructions include a single address such that the individual second user only has to send a single package that includes items being sold by the individual second user.

It should be noted that in some examples, while a single package is envisioned, a single seller may have a high volume of orders to fill, which may require more than one package for shipment. To further illustrate, a seller may have such a high quantity of orders to fill that all the items may not fit into a single package. Similarly, the items may be large in size, which limits the number of items that can be placed in a single package. In either scenario, the seller may have to use multiple packages. Nonetheless, in an example, the packages may be sent to the same address. In an example, based on receiving one of the instructions 164-168, each of the individual second users package the items indicated specified in one of the instructions 164-168 into a single package and then sends the single package to the single address.

To further illustrate this concept, the seller 124 can receive the instructions 164. The instructions 164 can indicate to the seller 124 that the seller 124 is to package up items that are sold by the seller 124 into a single package. In addition, the instructions 164 can specify an address to which the package prepared by the seller 124 should be sent. Likewise, the seller 126 can receive the instructions 166. The instructions 166 can indicate to the seller 126 that the seller 126 is to package up items that are sold by the seller 126 into a single package. In addition, the instructions 166 can specify an address to which the package prepared by the seller 126 should be sent. Similarly, the seller 128 can receive the instructions 168. The instructions 168 can indicate to the seller 128 that the seller 128 is to package up items that are sold by the seller 128 into a single package. In addition, the instructions 168 can specify an address to which the package prepared by the seller 128 should be sent.

In an example, the address specified in each of the instructions 164-168 can be based on a geographic location of the processing center 136. To further illustrate, the processing center 136 can service a particular geographical region, such as the Pacific Northwest. Moreover, each of the buyers 118-122 may be located in the Pacific Northwest. Therefore, in an example, each of the instructions 164-168 can specify an address associated with the processing center 136 in the first shipping instructions.

In a further example, buyers 174 and 176 can be located in the southeast that is serviced by a processing center 172 that provides items to buyers 174 and 176. In a further example, additional shipping instructions can be generated that are based on the additional processing center 172 being located at in the southeast and where different shipping addresses associated with the buyers 174 and 176 are associated with the processing center 172. Thus, the first shipping instructions, or additional shipping instructions if the seller is shipping to separate processing centers, can be generated that also list the shipping address associated with the processing center 172 in addition to the address associated with the processing center 136. It should be noted that while the buyers 118-122 are shown as being associated with the processing center 136, one of the buyers 118-122 can be associated with the processing center 172 in an example where one of the buyers 118-112 has an address in the southeast.

In addition, in an example, the first shipping instructions can include a time period after which each of the sellers 124-128 can ship items to the processing center 136. As noted above, examples relate to minimizing the number of packages the sellers 124-128 send to the processing center 136. By establishing a time period, such as three days, this increases the chances of the sellers 124-128 being able to send items for different buyers in one package to a processing center since different purchase requests may be submitted by different buyers at different times. Moreover, in an example, during the time period, additional purchase requests from buyers different from the buyers 118-122 can be received during the time period when the sellers 124-128 receive the shipping instructions. In this example, the operations 208-214 can be repeated for the additional purchase requests during the time period. Accordingly, if the time period is three days, the operations 208-214 can be repeated for three days for additional purchase requests that are created during the three day period as discussed with reference to the operations 202-206.

Returning to the example, as noted above, the selling platform 102 identified the bedding items 406, the area rug items 604, and the dinnerware items 808 as item clusters during the operation 210. Furthermore, the selling platform 102 matched the bedding items 406 to the seller 124, the area rug items 604 to the seller 126, and the dinnerware items 808 to the seller 128 during the operation 212. Thus, during the operation 214, the selling platform 102 generates the instructions 164 for the seller 124, the instructions 166 for the seller 126, and the instructions 168 for the seller 128.

In the example, the instructions 164 indicate that the seller 124 should provide three bedding items 406 in a single package. As noted above, the purchase request 158 indicated that each of the buyers wanted one bedding item 406. It should be noted that different amounts can be requested within the scope of the present disclosure. Moreover, the instructions 164 indicate that the seller 124 should send the single package that includes the three bedding items 406 to the processing center 136. Thus, in response to receiving the instructions 164, the seller 124 will prepare the package 138 to include three bedding items 406 and then send the package 138 to the processing center 136.

In the example, the instructions 166 indicate that the seller 126 should provide three area rug items 604 in a single package. As noted above, the purchase request 160 indicated that each of the buyers 118-122 wanted one area rug item 604. It should be noted that different amounts can be requested within the scope of the present disclosure. Moreover, the instructions 166 indicate that the seller 126 should send the single package that includes the three area rug items 604 to the processing center 136. Thus, in response to receiving the instructions 166, the seller 126 will prepare the package 140 to include three area rug items 604 and then send the package 140 to the processing center 136.

In the example, the instructions 168 indicate that the seller 128 should provide three dinnerware items 808 in a single package. As noted above, the purchase request 162 indicated that each of the buyers 118-122 wanted one dinnerware item 808. It should be noted that different amounts can be requested within the scope of the present disclosure. Moreover, the instructions 168 indicate that the seller 128 should send the single package that includes the three dinnerware items 808 to the processing center 136. Thus, in response to receiving the instructions 168, the seller 128 will prepare the package 142 to include three dinnerware items 808 and then send the package 142 to the processing center 136.

In an example, in addition to generating first shipping instructions for the individual second users during the operation 214, the method 200 generates second shipping instructions 170 that include sorting, address, and packaging instructions for a processing center during an operation 216. As noted above, each of the sellers receiving the first shipping instructions package items sold by the seller into a single package and then forward along the single package to the processing center. The items within the single package can be destined for different buyers. In accordance with an example, the items are removed from the packages at the processing center, sorted, and then repackaged. After repackaging, the items are sent to the buyers.

Regarding the sorting instructions, the second shipping instructions 170 can include how the items removed should be allocated. To further illustrate, the items may be sorted according to buyer. Thus, if three packages from three separate sellers that include individual packages for the three separate buyers are being sent to the processing center 136, the second shipping instructions 170 can include instructions indicating that the items in the three individual packages should be removed and sorted according to the three separate buyers, i.e., the first buyer is allocated a first package from the three individual packages, the second buyer is allocated a second package from the three individual packages, and the third buyer is allocated a third package from the three individual packages.

Regarding the address information, when a buyer sends a purchase request, such as the purchase requests 158-162, each of the purchase requests 158-162 include the recipient address 508. During the operation 216, the selling platform 102 can pull the recipient address 508 from the purchase requests 158-162 and provide the recipient address 508 in the second shipping instructions 170.

As noted above, the second shipping instructions 170 generated by the selling platform 102 can also include the packaging instructions. As such, in an example, the second shipping instructions 170 can indicate how items received from the buyers can be repackaged into packages destined for the buyers. To further illustrate, the three individual packages removed from the three packages sent from the three sellers for the first buyer can be repackaged into a single package to be sent to the first buyer, the three individual packages removed from the three packages sent from the three sellers for the second buyer can be repackaged into a single package to be sent to the second buyer. Similarly, the three individual packages removed from the three packages sent from the three sellers for the third buyer can be repackaged into a single package to be sent to the third buyer.

Returning to the example, during the operation 216, the selling platform 102 generates and then sends the second shipping instructions 170 to the processing center 136. The second shipping instructions 170 include instructions relating to sorting the packages 138-142 received at the processing center 136, address information for the buyers 118-122, and packaging instructions for the items 406, 604, and 808 purchased by the buyers 118-122. The processing center 136 receives the package 138 from the seller 124 that includes the bedding items 406 along with the package 140 from the seller 126 that includes the area rug items 604. Furthermore, the processing center 136 receives the package 142 from the seller 128 that includes the dinnerware items 808.

In the example, the selling platform 102 generates the second shipping instructions 170 to indicate that each of the buyers 118-122 receive one of the bedding items 406. Moreover, the selling platform 102 generates the second shipping instructions 170 to indicate that each of the buyers 118-122 receive one of the area rug items 604 along with one of the dinnerware items 808. Thus, the second shipping instructions 170 include sorting instructions to sort the bedding items 406 such that each of the buyers 118-122 receive one of the bedding items 406. The second shipping instructions 170 also include sorting instructions to sort the area rug items 604 such that each of the buyers 118-122 receive one of the area rug items 604. In addition, the second shipping instructions 170 include sorting instructions to sort the dinnerware items 808 such that each of the buyers 118-122 receive one of the dinnerware items 808.

In addition to the sorting instructions, the second shipping instructions 170 include address information associated with the locations 150-154 associated with each of the buyers 118-122. To further illustrate, as noted above, the purchase requests 158-162 include the recipient address 508 for each of the buyers 118-122 (only the address for the buyer 118 is shown). During the operation 216, the selling platform 102 pulls this address information from the purchase requests 158-162 and includes the address information in the second shipping instructions 170. In the example, the location 150 associated with the buyer 118 has the following address: 123 Main Street. Thus, during the operation 216, the selling platform 102 generates the second shipping instructions 170 to include the address of 123 Main Street for the package 144 to be sent to the buyer 118. Using a similar methodology, the selling platform 102 generates an address of 121 South Eighth Street for the location 152 associated with the buyer 120 and an address of 111 West Saint John Street for the location 154 associated with the buyer 122 for the packages 146 and 148 to be respectively sent to the buyers 120 and 122. This address information is provided to the processing center 136.

In the example, the selling platform 102 generates the second shipping instructions 170 to include instructions regarding how the processing center 136 should repackage the items 406, 604, and 808 sent in the packages 138-142. As noted above, the buyer 118 purchased the bedding item 406, the area rug item 604, and the dinnerware item 808. Thus, the repackaging instructions in the second shipping instructions 170 indicate that at least one of the bedding item 406, the area rug item 604, and the dinnerware item 808 should be repackaged into the single package 144 to be sent to the buyer 118.

Also as noted above, the buyer 120 purchased the bedding item 406, the area rug item 604, and the dinnerware item 808. Accordingly, the repackaging instructions in the second shipping instructions 170 indicate that at least one of the bedding item 406, the area rug item 604, and the dinnerware item 808 should be repackaged into the single package 146 to be sent to the buyer 120.

Moreover, the buyer 122 purchased the bedding item 406, the area rug item 604, and the dinnerware item 808. As such, the repackaging instructions in the second shipping instructions 170 indicate that at least one of the bedding item 406, the area rug item 604, and the dinnerware item 808 should be repackaged into the single package 148 to be sent to the buyer 122. Afterwards, in the example, the processing 136 sends each of the packages 144-148 to each of the buyers 118-122 at the address associated with the locations 150-154.

It should be noted that in the examples, discussion is made where the three buyers 118-122 purchase items from the sellers 124-128. However, in accordance with examples, only the buyers 118 and 120 may purchase items from of the sellers 124-128 while the buyer 122 purchases items from the sellers 124 and 126. In this example, in the package 142 from the seller 128 will includes items for the buyers 118 and 120. In this example, the instructions 168 sent to the seller 128 will reflect only placing items for the buyers 118 and 120. Moreover, the instructions 170 will reflect preparing the package 148 to include only the items from the sellers 124 and 126. thus, the number of buyers purchasing items is variable such that the instructions 164-168 can vary depending on which of the buyers 118-122 purchase items from the various sellers 124-128. Moreover, the contents of the packages 144-148 sent to the buyers 118-122 can be different from one another.

It should be noted that in alternative examples, the operation 210 can be skipped where once the purchase requests are received during the operation 208, the items in the purchase requests are matched to individual second users of the plurality of second users. To further illustrate this concept, in an illustration, when a purchase request is received from the buyer 118 for the dinnerware item being sold by the seller 168, the selling platform 102 matches the purchase request for the dinnerware item to the seller 168 and sends shipping instructions to the seller 168. In the alternative example, when a purchase request is received from the buyer 120 for the dinnerware item being sold by the seller 168 after shipping instructions for the buyer 118 are sent to the seller 168, the selling platform 102 matches the purchase request for the dinnerware item to the seller 168 and sends shipping instructions to the seller 168. In the alternative example, the operation 210 that identifies the item groups can be skipped. In the alternative example, during the operation 212, instead of matching the item groups to individual second users, the item is matched to individual second users of the plurality of second users. Thus, the dinnerware item is matched to the seller 168, as noted above.

Furthermore, in the examples given above, the items, such as the bedding items 404-408, the area rug items 604-608, and the dinnerware items 804-808 are related to housewares. In further examples, the items being sold by the sellers 124-128 could be unrelated. To further illustrate, the seller 124 can sell automotive parts, the seller 126 can sell clothing, and the seller 128 can sell hair products. In this example, each of the buyers 118-122 can still purchase items from each of the sellers 124-128.

The described techniques provide a specific improvement over prior systems, such as systems that allow a plurality of first users to obtain items from a plurality of seconds users. The specific improvement results in an improved user interface for electronic devices that allow a plurality first users to obtain items from a plurality of seconds users. Additionally, the described techniques provide a particular manner of summarizing and presenting information in electronic devices by providing the first plurality of users the ability to select various objects at a first user interface and then causing the display of a second user interface that summarizes the object selections at the first user interface, without using conventional user interface methods such as displaying a generic index on a computer. Inputs received at a first interface cause the generation of a second user interface based on the inputs received at the first user interface. Furthermore, inputs received at the user interfaces described herein cause a processing device to perform actions related to inputs received at the user interfaces.

FIG. 11 is a block diagram 1100 illustrating a software architecture 1102, which may be installed on any one or more of the devices described above. FIG. 11 is merely a non-limiting example of a software architecture, and it will be appreciated that many other architectures may be implemented to facilitate the functionality described herein. The software architecture 1102 may be implemented by hardware such as a machine 1300 that includes processors 1310, memory 1330, and I/O components 1350. In this example, the software architecture 1102 may be conceptualized as a stack of layers where each layer may provide a particular functionality. For example, the software architecture 1102 includes layers such as an operating system 1104, libraries 1106, frameworks 1108, and applications 1110. Operationally, the applications 1110 invoke application programming interface (API) calls 1112 through the software stack and receive messages 1114 in response to the API calls 1112, according to some implementations.

In various implementations, the operating system 1104 manages hardware resources and provides common services. The operating system 1104 includes, for example, a kernel 1120, services 1122, and drivers 1124. The kernel 1120 acts as an abstraction layer between the hardware and the other software layers in some implementations. For example, the kernel 1120 provides memory management, processor management (e.g., scheduling), component management, networking, and security settings, among other functionality. The services 1122 may provide other common services for the other software layers. The drivers 1124 may be responsible for controlling or interfacing with the underlying hardware. For instance, the drivers 1124 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

In some implementations, the libraries 1106 provide a low-level common infrastructure that may be utilized by the applications 1110. The libraries 1106 may include system libraries 1130 (e.g., C standard library) that may provide functions such as memory allocation functions, string manipulation functions, mathematic functions, and the like. In addition, the libraries 1106 may include API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 1106 may also include a wide variety of other libraries 1134 to provide many other APIs to the applications 1110.

The frameworks 1108 provide a high-level common infrastructure that may be utilized by the applications 1110, according to some implementations. For example, the frameworks 1108 provide various graphic user interface (GUI) functions, high-level resource management, high-level location services, and so forth. The frameworks 1108 may provide a broad spectrum of other APIs that may be utilized by the applications 1110, some of which may be specific to a particular operating system or platform.

In an example example, the applications 1110 include a home application 1150, a contacts application 1152, a browser application 1154, a book reader application 1156, a location application 1158, a media application 1160, a messaging application 1162, a game application 1164, and a broad assortment of other applications such as a third-party application 1166. According to some examples, the applications 1110 are programs that execute functions defined in the programs. Various programming languages may be employed to create one or more of the applications 1110, structured in a variety of manners, such as object-orientated programming languages (e.g., Objective-C, Java, or C++) or procedural programming languages (e.g., C or assembly language). In a specific example, the third-party application 1166 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 1166 may invoke the API calls 1112 provided by the mobile operating system (e.g., the operating system 1104) to facilitate functionality described herein.

Certain examples are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In examples, one or more computer systems (e.g., a standalone, client or server computer system) or one or more processors may be configured by software (e.g., an application or application portion) as a hardware-implemented module that operates to perform certain operations as described herein.

In various examples, a hardware-implemented module may be implemented mechanically or electronically. For example, a hardware-implemented module may include dedicated circuitry or logic that is permanently configured (e.g., as a special-purpose processor, such as a field programmable gate array (FPGA) or an application-specific integrated circuit (ASIC)) to perform certain operations. A hardware-implemented module may also include programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering examples in which hardware-implemented modules are temporarily configured (e.g., programmed), each of the hardware-implemented modules need not be configured or instantiated at any one instance in time. For example, where the hardware-implemented modules include a general-purpose processor configured using software, the general-purpose processor may be configured as respectively different hardware-implemented modules at different times. Software may, accordingly, configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses) that connects the hardware-implemented modules. In examples in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some examples, include processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but also deployed across a number of machines. In some examples, the processor or processors may be located in a single location (e.g., within a home environment, an office environment or as a server farm), while in other examples, the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network 115 (e.g., the Internet) and via one or more appropriate interfaces (e.g., application program interfaces (APIs).)

Examples may be implemented in digital electronic circuitry, or in computer hardware, firmware, software, or in combinations of them. Examples may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers, at one site or distributed across multiple sites, and interconnected by a communication network.

The computing system can include clients and servers. A client and server are generally remote from each other and typically interact through a communication network. The relationship of client and server arises by virtue of computer programs running on the respective computers and having a client-server relationship to each other. In examples deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various examples.

FIG. 12 is a block diagram of a machine within which instructions may be executed for causing the machine to perform any one or more of the methodologies discussed herein. In one example, the machine may be any of the devices described above. In alternative examples, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that, individually or jointly, execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation device (cursor control device) 1214 (e.g., a mouse), a disk drive unit 1216, a signal generation device 1218 (e.g., a speaker) and a network interface device 1220.

The drive unit 1216 includes a machine-readable medium 1222 on which is stored one or more sets of instructions and data structures (e.g., software) 1224 embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media. Instructions 1224 may also reside within the static memory 1206.

While the machine-readable medium 1222 is shown in an example to be a single medium, the term “machine-readable medium” may include a single medium or multiple media (e.g., a centralized or distributed database, and/or associated caches and servers) that store the one or more instructions or data instructions 1224. The term “machine-readable medium” shall also be taken to include any tangible medium that is capable of storing, encoding or carrying instructions 1224 for execution by the machine and that cause the machine to perform any one or more of the methodologies of the present invention, or that is capable of storing, encoding or carrying data structures utilized by or associated with such instructions 1224. The term “machine-readable medium” shall accordingly be taken to include, but not be limited to, solid-state memories, and optical and magnetic media. Specific examples of machine-readable media include non-volatile memory, including by way of example, semiconductor memory devices, e.g., erasable programmable read-only memory (EPROM), electrically erasable programmable read-only memory (EEPROM), and flash memory devices; magnetic disks, such as internal hard disks and removable disks; magneto-optical disks; and CD-ROM and DVD-ROM disks.

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding or carrying instructions 1224 for execution by the machine, and includes digital or analog communications signals or other intangible media to facilitate communication of such software.

Although an example has been described with reference to specific examples, it will be evident that various modifications and changes may be made to these examples without departing from the broader spirit and scope of the invention. Accordingly, the specification and drawings are to be regarded in an illustrative rather than a restrictive sense. The accompanying drawings that form a part hereof, show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

Such examples of the inventive subject matter may be referred to herein, individually and/or collectively, by the term “invention” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example.

What is claimed is:

1. A method, comprising:
causing to be displayed at a user device associated with each of a plurality of first users, a first user interface that includes an option to search a first item;
in response to a selection of the option to search for the first item, causing to be displayed at the user device associated with each of the plurality of first users a second user interface that includes an option to select a purchase request corresponding to the item;
repeating the display of the first user interface and the second user interface for a second item;
receiving, from the plurality of first users, a plurality of purchase requests for the first item and the second item sold by a plurality of second users, the plurality of first users being associated with different shipping addresses and being received in response to the plurality of users selecting a purchase request for the first item and the second item;
matching the items of the plurality purchase requests to individual second users of the plurality of second users to generate matched purchase requests;
generating first shipping instructions for the individual second users to send a single shipment to a processing center;
generating second shipping instructions for the processing center that comprise address instructions to determine shipping addresses based on the items from the single shipments, the plurality of purchase requests, and the different shipping address associated with the plurality of first users for the sorted items; and
sending the second shipping instructions to the processing center.

2. The method of claim 1, wherein the first shipping instructions indicate that the single shipment has the items purchased by the different first users of the plurality of first users is to be sent to a processing center

3. The method of claim 1, the method further comprising sending the first shipping instructions and the matched purchase requests to the individual second users.

4. The method of claim 1, where the second shipping instructions further comprise:
sorting instructions to sort the items from single shipments received from the individual second users according to the different first users; and
packaging instructions to package the sorted items according to the shipping addresses such that the processing center sends a single package intended for a single first user of the plurality first users to each of the plurality of first users.

5. The method of claim 1, wherein the individual second user is a seller selling a single item, where the first item is the single item and the purchase requests include a request for the single item such that multiple first users associated with the different shipping addresses request the single item and the single shipment includes multiples of the single item intended for the multiple first users associated the different shipping addresses, the multiples of the single items being sorted and packaged according to the sorting instructions and the packaging instructions such that each first user of the multiple first users is individually sent the single item from the multiples of the single item.

6. The method of claim 1, wherein the processing center is located at a first geographic location and generating the first and second shipping instructions is based on the first geographic location and the method further includes generating third shipping instructions, the third shipping instructions being based on an additional processing center located at a second geographic location and ones of the different shipping addresses associated with the plurality of first users.

7. The method of claim 1, wherein the first shipping instructions further include:
a time period; and
instructions to the individual second users to wait to send the single shipment until expiration of the time period and the method further comprises:
receiving a second plurality of purchase requests from a second plurality of first users; and
repeating the operations of matching the items of the plurality purchase requests to individual second users of the plurality of second users, generating, and sending the first shipping instructions for the second plurality of purchase requests.

8. A system comprising:
a processor; and
a memory storing instructions that, when executed by the processor, configure the system to perform operations comprising:
causing to be displayed at a user device associated with each of a plurality of first users, a first user interface that includes an option to search a first item;
in response to a selection of the option to search for the first item, causing to be displayed at the user device associated with each of the plurality of first users a second user interface that includes an option to select a purchase request corresponding to the item;
repeating the display of the first user interface and the second user interface for a second item;
receiving, from the plurality of first users, a plurality of purchase requests for the first item and the second item sold by a plurality of second users, the plurality of first users being associated with different shipping addresses and being received in response to the plurality of users selecting a purchase request for the first item and the second item;
matching the items of the plurality purchase requests to individual second users of the plurality of second users to generate matched purchase requests;
generating first shipping instructions for the individual second users to send a single shipment to a processing center;
generating second shipping instructions for the processing center that comprise address instructions to determine shipping addresses based on the items from the single shipments, the plurality of purchase requests, and the different shipping address associated with the plurality of first users for the sorted items; and
sending the second shipping instructions to the processing center.

9. The system of claim 8, wherein the first shipping instructions indicate that the single shipment has the items purchased by the different first users of the plurality of first users is to be sent to a processing center

10. The system of claim 8, wherein the instructions further configure the system to perform operations comprising sending the first shipping instructions and the matched purchase requests to the individual second users.

11. The system of claim 8, wherein the instructions further configure the system to perform operations comprising:
sorting instructions to sort the items from single shipments received from the individual second users according to the different first users; and
packaging instructions to package the sorted items according to the shipping addresses such that the processing center sends a single package intended for a single first user of the plurality first users to each of the plurality of first users.

12. The system of claim 8, wherein the individual second user is a seller selling a single item, where the first item is the single item and the purchase requests include a request for the single item such that multiple first users associated with the different shipping addresses request the single item and the single shipment includes multiples of the single item intended for the multiple first users associated the different shipping addresses, the multiples of the single items being sorted and packaged according to the sorting instructions and the packaging instructions such that each first user of the multiple first users is individually sent the single item from the multiples of the single item.

13. The system of claim 8, wherein the processing center is located at a first geographic location and generating the first and second shipping instructions is based on the first geographic location and the instructions further configure the system to perform operations comprising generating third shipping instructions, the third shipping instructions being based on an additional processing center located at a second geographic location and ones of the different shipping addresses associated with the plurality of first users.

14. The system of claim 8, wherein the first shipping instructions further include:
a time period; and
instructions to the individual second users to wait to send the single shipment until expiration of the time period and the instructions further configure the system to perform operations comprising:
receiving a second plurality of purchase requests from a second plurality of first users; and
repeating the operations matching the items of the plurality purchase requests to individual second users of the plurality of second users, generating, and sending the first shipping instructions for the second plurality of purchase requests.

15. A non-transitory computer-readable storage medium, the computer-readable storage medium including instructions that when executed by a computer, cause the computer to perform operations comprising:
causing to be displayed at a user device associated with each of a plurality of first users, a first user interface that includes an option to search a first item;
in response to a selection of the option to search for the first item, causing to be displayed at the user device associated with each of the plurality of first users a second user interface that includes an option to select a purchase request corresponding to the item;
repeating the display of the first user interface and the second user interface for a second item;
receiving, from the plurality of first users, a plurality of purchase requests for the first item and the second item sold by a plurality of second users, the plurality of first users being associated with different shipping addresses and being received in response to the plurality of users selecting a purchase request for the first item and the second item;
matching the items of the plurality purchase requests to individual second users of the plurality of second users to generate matched purchase requests;
generating first shipping instructions for the individual second users to send a single shipment to a processing center;
generating second shipping instructions for the processing center that comprise address instructions to determine shipping addresses based on the items from the single shipments, the plurality of purchase requests, and the different shipping address associated with the plurality of first users for the sorted items; and
sending the second shipping instructions to the processing center.

16. The non-transitory computer-readable storage medium of claim 15, wherein the first shipping instructions indicate that the single shipment has the items purchased by the different first users of the plurality of first users is to be sent to a processing center

17. The non-transitory computer-readable storage medium of claim 15, wherein the instructions further configure the system to perform operations comprising sending the first shipping instructions and the matched purchase requests to the individual second users.

18. The non-transitory computer-readable storage medium of claim 15, wherein the instructions further cause the computer to perform operations comprising:
sorting instructions to sort the items from single shipments received from the individual second users according to the different first users; and
packaging instructions to package the sorted items according to the shipping addresses such that the processing center sends a single package intended for a single first user of the plurality first users to each of the plurality of first users.

19. The system of claim 8, wherein the individual second user is a seller selling a single item, where the first item is the single item and the purchase requests include a request for the single item such that multiple first users associated with the different shipping addresses request the single item and the single shipment includes multiples of the single item intended for the multiple first users associated the different shipping addresses, the multiples of the single items being sorted and packaged according to the sorting instructions and the packaging instructions such that each first user of the multiple first users is individually sent the single item from the multiples of the single item.

20. The system of claim 8, wherein the processing center is located at a first geographic location and generating the first and second shipping instructions is based on the first geographic location and the instructions further cause the computer to perform operations comprising generating third shipping instructions, the third shipping instructions being based on an additional processing center located at a second geographic location and ones of the different shipping addresses associated with the plurality of first users, wherein the first shipping instructions further include:
a time period; and
instructions to the individual second users to wait to send the single shipment until expiration of the time period and the instructions further cause the computer to perform operations comprising:
receiving a second plurality of purchase requests from a second plurality of first users; and
repeating the operations of matching the items of the plurality purchase requests to individual second users of the plurality of second users, generating, and sending the first shipping instructions for the second plurality of purchase requests.
